(19) United States
(12) Patent Application Publication
(10) Pub. No.: US 2006/0021820 A1
(43) Pub. Date: Feb. 2, 2006

(54) Hydraulic servo-steering valve with steering torque overlay

(76) Inventor: Heinz-Dieter Heitzer, Heinsberg (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/191,596

(22) Filed: Jul. 28, 2005

(30) Foreign Application Priority Data
Jul. 28, 2004 (DE) 20 2004 011 804.1

(51) Int. Cl. B62D 5/06

(52) U.S. Cl. 180/441

(57) ABSTRACT

A servo-steering valve for a hydraulic servo-steering arrangement includes an input shaft, an output shaft and a valve. The valve comprises first and second valve members. The first and second valve members are rotatable relative to each other upon rotation of the input shaft relative to the output shaft. One of the valve members is rotatably arranged. The servo-steering valve further comprises a restoring element. The rotatable valve member is biased by the restoring element so as to assume a non-rotated initial position.

### TECHNICAL FIELD

The invention relates to a servo-steering valve for a hydraulic servo-steering arrangement.

### BACKGROUND OF THE INVENTION

Servo-steering valves, comprising an input shaft, an output shaft and a valve which comprises first and second valve members, the first and second valve members being rotatable relative to each other upon rotation of the input shaft relative to the output shaft with one of the valve members being rotatable arranged, are generally known. One of the valve members is usually a valve sleeve and the other valve member is a valve shaft. The rotation of the valve sleeve relative to the valve shaft brings it about that as a function of the direction of rotation, a hydraulic flow is provided in one or the other direction. This hydraulic flow is converted into a steering assistance force in a hydraulic cylinder. The amount of the steering assistance force depends on the steering moment which is applied by the driver to the input shaft via the steering wheel.

In modern steering systems, it is desirable that the steering process can be influenced from the exterior. In other words, the hitherto single input to the servo-steering valve, namely the steering moment exerted by the driver, is to be superimposed with an overlay value, which leads to a modification of the steering command. It happens in this way that systems for automatic vehicle stabilization, for instance, can act on the driving behavior of the vehicle. Finally, the steering characteristic of the steering system felt by the driver via the steering wheel (the “steering feel”) can be altered.

The overlay value is generated in that one of the two valve members is arranged rotatably on the input shaft or on the output shaft, e.g. the valve sleeve, and in that the valve member is moved in one or the other direction by an adjustment drive as a function of external parameters. In this way, an actuation in one or the other direction can be simulated to the servo-steering gear, although the driver has not actually actuated the input shaft at all. Nevertheless, owing to the rotation of the valve sleeve, a servo force is generated which acts as the superimposition value.

A problem in such a steering gear is the security against failure. If the adjustment gear fails at a moment in which the valve sleeve is moved by the maximum possible angle amount in one or the other direction, a maximum servo force would be permanently generated in one or the other direction. This is undesirable.

It is an object of the invention to refine a known type of servo-steering valves to the effect that the security against failure is improved.

### BRIEF SUMMARY OF THE INVENTION

The servo-steering valve according to the invention is intended for a hydraulic servo-steering arrangement and includes an input shaft, an output shaft and a valve. The valve comprises first and second valve members. The first and second valve members are rotatable relative to each other upon rotation of the input shaft relative to the output shaft. One of the valve members is rotatably arranged. The servo-steering valve further comprises a restoring element. The rotatable valve member is biased by a restoring element so as to assume a non-rotated initial position. The restoring element ensures that the rotatable valve member, when the adjustment drive fails, is restored into the initial position. At the same time it ensures that the rotatable valve member, on actuation of the steering valve, is not rotated out of its initial position, owing to the friction forces which are occurring, for example.

According to a preferred embodiment of the invention, the restoring element comprises a pre-stressed spring ring. This embodiment is distinguished by a very small structural space and by a mechanically simple and thereby favorably priced construction which is secure against failure.

As adjustment drive for the adjustable valve member, in particular a harmonic drive is suitable which brings about the necessary rotation of the components relative to each other. The harmonic drive is distinguished by a small space requirement with, at the same time, a very high reduction factor.

Advantageous developments of the invention will be apparent from the sub-claims.

### BRIEF DESCRIPTION OF THE DRAWINGS

FIGS. 1a and 1b show in diagrammatic views a servo-steering valve according to the invention and including an adjustment drive, the valve sleeve being in the initial position;

FIG. 2 shows on an enlarged scale the region II of FIG. 1, the valve sleeve having been rotated out of the initial position; and

FIG. 3 shows in a perspective view the restoring element used in the servo-steering valve of FIGS. 1 and 2.

### DETAILED DESCRIPTION OF THE PREFERRED EMBODIMENT

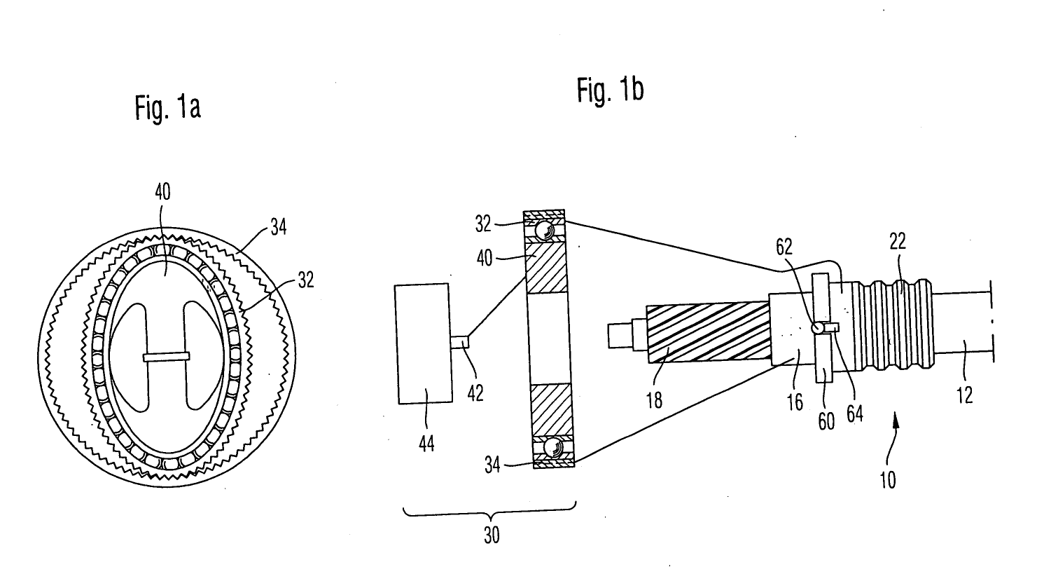

In FIG. 1 a servo-steering valve 10 is shown diagrammatically. The servo-steering valve 10 has an input shaft 12 and an output shaft 16. The input shaft 12 is coupled with a steering wheel (not shown). The output shaft 16 is provided with teeth 18 cooperating with a rack (not illustrated), which in turn is connected via a steering linkage with steerable vehicle wheels. The gear train from the output shaft 16 can also be realized in a different manner, of course.

A valve is provided, which consists of a valve sleeve 22 and a valve shaft arranged inside the valve sleeve 22. The valve shaft is formed on the input shaft 12 or constructed so as to be a part thereof. By rotating the valve shaft relative to the valve sleeve 22, a hydraulic flow is controlled, which can be delivered to a hydraulic cylinder in order to generate a steering assistance force. Usually, a torsion rod is associated to the input shaft 12 and to the output shaft 16, which urges the input shaft 12 and the output shaft 16 relative to each other into a central position. The maximum possible rotation of the input shaft 12 relative to the output shaft 16 is dictated by mechanical stops. The mode of operation of the servo-steering valve described here is known generally from prior art.

The valve sleeve 22 is rotatably mounted on the output shaft 16. This makes it possible, by rotating the valve sleeve 22 out of an initial position, to modify the input of the servo-steering valve, given by the actuation of the input shaft 12. In order to rotate the valve sleeve 22, an adjustment drive 30 is provided, which is constructed here as a harmonic drive. The harmonic drive has a flexible inner ring 32, which is provided on its outer side with teeth that mesh with teeth formed on the inner side of an outer ring 34. The inner ring 32 is connected for joint rotation with the valve sleeve 22, and the outer ring 34 is connected for joint rotation with the output shaft 16. Inside the flexible inner ring 32, a drive disc 40 of the harmonic drive is arranged. The drive disc 40 is coupled with a drive motor 44. By actuation of the drive motor 44, the valve sleeve 22 can be rotated relative to the output shaft 16 via the harmonic drive. In this way, the input provided via the input shaft 12 is superimposed with an overlay value. This can serve in particular to have influence on the servo assistance provided by the servo-steering valve, without the input shaft 12 being rotated.

A restoring element 60 is provided, which is constructed here as a C-shaped spring ring. The spring ring extends over an angle range of almost 360° and is arranged on the output shaft 16. Its two ends are associated with two pins 62, 64. Pin 62 is arranged on the output shaft 16, and pin 64 is arranged on the valve sleeve 22. The spring ring 60 is pre-stressed in the initial state so that it urges the two pins 62, 64 into the position shown in FIGS. 1 and 3, in which the two pins 62, 64 rest against the two end faces of the spring ring 60. The two pins 62, 64 thus lie on the same radius, in relation to the central axis of the valve sleeve 22 and the output shaft 16.

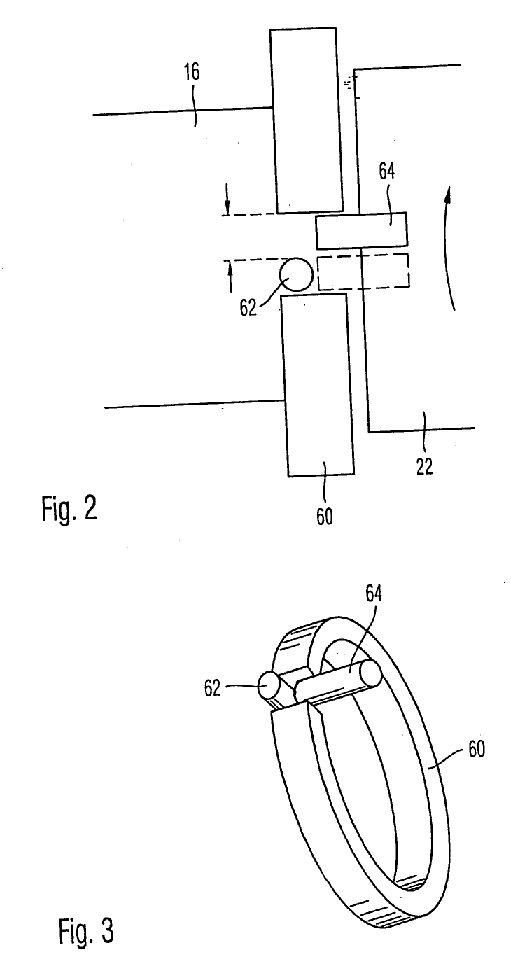

When the adjustment drive 30 moves the valve sleeve 22, in the direction of the arrow of FIG. 2, for example, pin 64 moves away from pin 62 (see FIG. 2), whereby the spring ring 60 is widened against an elastic restoring force. If the adjustment drive fails in this state, the restoring force exerted by the spring ring 60 is large enough to return the valve sleeve 22 relative to the output shaft 16 into its initial position again (see the position of the pin 64 of the valve sleeve 22 shown in broken lines in FIG. 2). Thereby, it is ensured that the servo-steering valve operates in a conventional manner in the case of a failure of the adjustment arrangement, the servo-steering valve in particular having a symmetrical characteristic.

1. A servo-steering valve for a hydraulic servo-steering arrangement, said servo-steering valve comprising an input shaft, an output shaft and a valve which comprises first and second valve members, said first and second valve members being rotatable relative to each other upon rotation of said input shaft relative to said output shaft, one of said valve members defining a rotatable valve member movable between a non-rotated initial position and a rotated position, said servo-steering valve further comprising a restoring element, said rotatable valve member being biased by said restoring element to said, non-rotated initial position.

2. The servo-steering valve according to claim 1, wherein said rotatable valve member is a valve sleeve.

3. The servo-steering valve according to claim 1, wherein said rotatable valve member can be rotated relative to said output shaft.

4. The servo-steering valve according to claim 2, wherein said restoring element comprises a pre-stressed spring ring.

5. The servo-steering valve according to claim 4, wherein said spring ring extends over an angle range of approximately 360°.

6. The servo-steering valve according to claim 4, wherein said spring ring is supported on said output shaft and on said valve sleeve.

7. The servo-steering valve according to claim 6, wherein said spring ring is supported by pins which are arranged on said output shaft and on said valve sleeve, respectively.

8. The servo-steering valve according to claim 7, wherein said pins, when said valve sleeve is in said initial position, are situated on the same radius.

9. The servo-steering valve according to claim 1, wherein an adjustment drive is provided, which can rotate said rotatable valve member.

10. The servo-steering valve according to claim 9, wherein said adjustment drive is a harmonic drive.

11. The servo-steering valve according to claim 1, wherein said restoring element is a spring.

12. The servo-steering valve according to claim 11, wherein said spring comprises a pre-stressed spring ring.
